(19) United States
(12) Patent Application Publication
(10) Pub. No.: US 2026/0225278 A1
(43) Pub. Date: Aug. 6, 2026

(54) CARTRIDGE-TYPE SECONDARY BATTERY ELECTRODE CUTTING MODULE

(71) Applicant: Yujin Technology Co., Ltd., Chungcheongbuk-do (KR)

(72) Inventors: Hyun Guk YEO, Chungcheongbuk-do (KR); Mi Yeon LEE, Chungcheongbuk-do (KR); Jeon Young KANG, Gyeonggi-do (KR); Sang Keun YU, Chungcheongbuk-do (KR); Sang Hyun PARK, Chungcheongbuk-do (KR); Seon Uk KIM, Chungcheongbuk-do (KR)

(21) Appl. No.: 19/455,296

(22) Filed: Jan. 21, 2026

(30) Foreign Application Priority Data
Jan. 22, 2025 (KR) 10-2025-0009224

(51) Int. Cl. B26D 7/26; B26D 1/08; H01M 4/04; H01M 10/04

(52) U.S. Cl. CPC B26D 7/2628; B26D 1/085; B26D 7/2614; H01M 4/04; H01M 10/04

(57) ABSTRACT

The disclosed cartridge-type secondary battery electrode cutting module comprises: an upper blade configured to be mounted on an upper blade holder; a lower blade configured to be mounted on a lower blade holder; and an adjustment assembly having a holder support for mounting the upper blade holder, and a clearance adjustment unit and a squareness adjustment unit for adjusting a clearance and squareness between the upper blade and the lower blade by elastically pressing and tilting the upper blade holder.

### CROSS-REFERENCE TO RELATED APPLICATIONS

This application is a claims benefit of Korean Patent Application No. 10-2025-0009224, filed on Jan. 22, 2025. The entire disclosure of the applications identified in this paragraph are incorporated herein by references.

### FIELD

The present disclosure relates to a cartridge-type secondary battery electrode cutting module capable of easily adjusting the clearance and squareness between an upper blade and a lower blade.

### BACKGROUND

Generally, a secondary battery is manufactured through an electrode process, an assembly process, a formation process, etc. In the electrode process, electrode tabs (hereinafter referred to as ‘tabs’) are formed on the uncoated portion of a positive electrode plate or a negative electrode plate (hereinafter referred to as ‘electrode’).

Equipment for forming these tabs includes press notching equipment and laser notching equipment. The notching equipment forms tabs on an electrode sheet that is continuously unwound from a roll shape.

The electrode sheet with the tabs formed thereon is cut to a set size to be manufactured as a unit electrode, or is wound again in a roll shape and then cut to a set size while being unwound toward stacking equipment in the assembly process to be manufactured as a unit electrode.

As an apparatus for cutting the aforementioned electrode sheet, a conventional guillotine-type cutting apparatus that cuts the electrode sheet perpendicularly to the transport direction of the electrode sheet is mainly used.

Such a cutting apparatus includes an upper blade and a lower blade. When the electrode sheet is transported between the upper blade and the lower blade, the upper blade or the lower blade is operated to move up and down to cut the electrode sheet in the width direction, thereby manufacturing a unit electrode.

In addition, recently, cartridge-type secondary battery electrode cutting modules that allow the modularized upper and lower blades to be attached to and detached from a cutting drive unit have been disclosed so that the replacement work of the upper and lower blades can be performed simply and easily.

Meanwhile, in the cutting module having the above-described upper and lower blades, the factor that has the greatest influence on cutting quality is the management of the clearance and squareness (straightness) between the upper blade and the lower blade within a required tolerance range.

However, the conventional cutting module has a problem in that it is not easy to adjust the clearance and squareness (straightness) between the upper blade and the lower blade.

### SUMMARY

### Technical Problem

The objective of the present disclosure is to provide a cartridge-type secondary battery electrode cutting module that facilitates the adjustment of clearance and squareness between an upper blade and a lower blade and can quantitatively guarantee the clearance and squareness.

### Technical Solution

To solve the above problems, a cartridge-type secondary battery electrode cutting module according to an aspect of the present disclosure may comprise: an upper blade configured to be mounted on an upper blade holder; a lower blade configured to be mounted on a lower blade holder; and an adjustment assembly having a holder support for mounting the upper blade holder, and a clearance adjustment unit and a squareness adjustment unit for adjusting a clearance and squareness between the upper blade and the lower blade by elastically pressing and tilting the upper blade holder.

In the cartridge-type secondary battery electrode cutting module according to an aspect of the present disclosure, the upper blade holder support may include: a first mount frame formed to extend in a width direction of an electrode sheet; a second mount frame formed to extend in the width direction of the electrode sheet and fixedly installed to the first mount frame such that a front surface thereof faces a rear surface of the first mount frame; and adjustment shafts that horizontally pass through through-holes formed on an upper side of the upper blade holder so as to be spaced apart from each other, and support the upper blade holder between the first and second mount frames such that the upper blade holder can move back and forth and tilt.

In the cartridge-type secondary battery electrode cutting module according to an aspect of the present disclosure, an adjustment groove into which the upper side of the upper blade holder is fitted so as to be movable back and forth and tiltable is formed in the first mount frame, and the adjustment groove may be formed to be opened toward the rear surface side of the first mount frame while extending from a lower portion to an upper side of the first mount frame.

In the cartridge-type secondary battery electrode cutting module according to an aspect of the present disclosure, a first tilting groove into which front ends of the adjustment shafts are tiltably fitted via self-aligning ball bearings is formed in the first mount frame, and a second tilting groove extending in a vertical direction, into which rear ends of the adjustment shafts are tiltably fitted in the vertical direction, may be formed in the second mount frame.

In the cartridge-type secondary battery electrode cutting module according to an aspect of the present disclosure, ball bushings may be fixedly installed in the through-holes so that the upper blade holder can move back and forth along the adjustment shafts.

In the cartridge-type secondary battery electrode cutting module according to an aspect of the present disclosure, the clearance adjustment unit may comprise a plurality of clearance adjustment mechanisms, each mechanism comprising: a clearance adjustment compression coil spring fitted into a clearance adjustment hole formed in the first mount frame such that a rear end thereof can press a front side of the upper blade holder; and a clearance adjustment bolt fastened to be inserted into or withdrawn from the clearance adjustment hole to allow the clearance adjustment compression coil spring to elastically press the front surface of the upper blade holder.

In the cartridge-type secondary battery electrode cutting module according to an aspect of the present disclosure, the squareness adjustment unit may comprise a plurality of squareness adjustment mechanisms, each mechanism comprising: a squareness adjustment compression coil spring fitted into a first squareness adjustment hole formed at a lower side of the second tilting groove, an upper end of which elastically supports a lower side connected to the rear end of a corresponding one of the adjustment shafts; and a squareness adjustment bolt fastened to be inserted into or withdrawn from a second squareness adjustment hole formed through an upper portion of the second mount frame at an upper side of the second tilting groove, to press an upper side connected to the rear end of the corresponding one of the adjustment shafts so as to tilt the upper blade holder and the upper blade in the vertical direction.

### Advantageous Effects

According to the present invention, since the adjustment of the clearance and squareness between the upper blade and the lower blade is easy, an effect is provided that allows anyone, even if not a skilled worker, to easily adjust the clearance and squareness between the upper blade and the lower blade.

According to the present invention, since the clearance and squareness between the upper blade and the lower blade can be quantitatively guaranteed, an effect of maintaining consistent cutting quality is provided.

### BRIEF DESCRIPTION OF DRAWINGS

FIG. 1 is a view schematically showing a cartridge-type secondary battery electrode cutting module according to the present invention, and

FIG. 2 is an enlarged cross-sectional view taken along line A-A of FIG. 1.

### DETAILED DESCRIPTION

Hereinafter, embodiments implementing the cartridge-type secondary battery electrode cutting module according to the present invention will be described in detail with reference to the drawings.

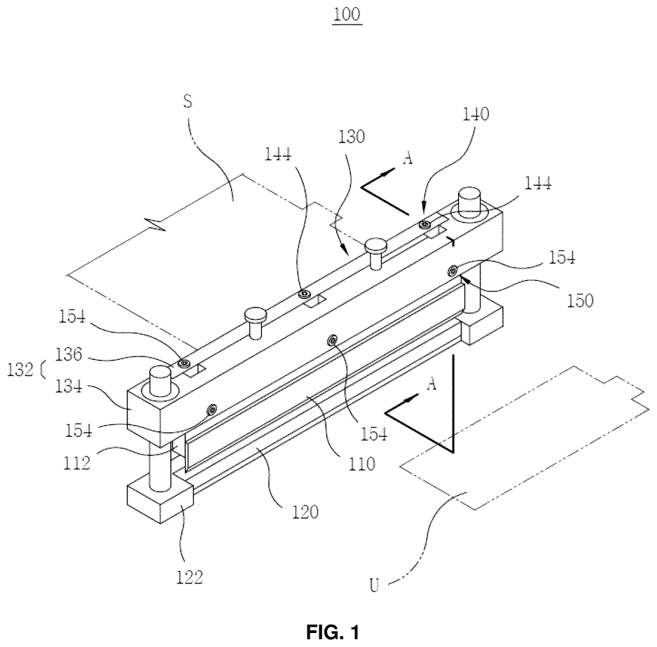

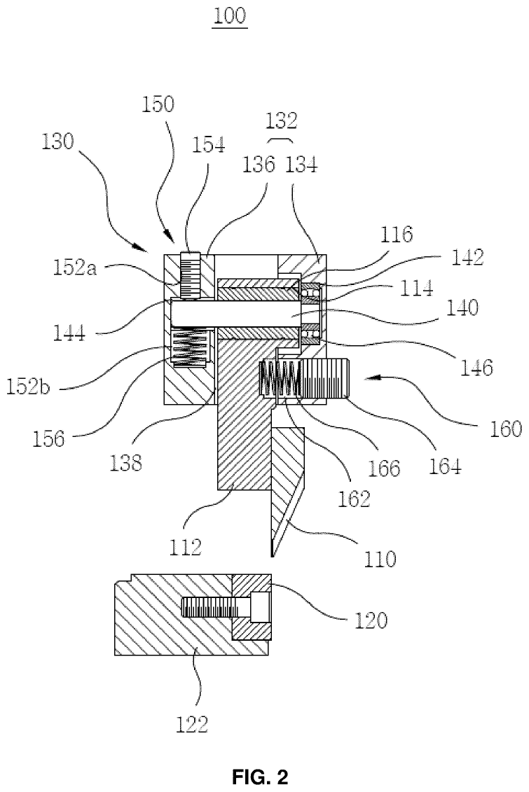

FIGS. 1 and 2 are views schematically showing a cartridge-type secondary battery electrode cutting module according to the present invention.

Referring to FIGS. 1 and 2, the cartridge-type secondary battery electrode cutting module 100 according to the present invention includes an upper blade 110 and a lower blade 120, and an adjustment assembly 130 for quantitatively adjusting a clearance and squareness between the upper blade 110 and the lower blade 120.

The upper blade 110 and the lower blade 120 cut an electrode sheet S in a width direction to manufacture unit electrodes U.

The upper blade 110 and the lower blade 120 extend in the width direction of the electrode sheet S, and the upper blade 110 and the lower blade 120 are installed to be mounted on an upper blade holder 112 and a lower blade holder 122, which similarly extend in the width direction of the electrode sheet S.

Here, since the connection relationship between the upper blade 110 and the upper blade holder 112 and the connection relationship between the lower blade 120 and the lower blade holder 122 are substantially the same as those of a conventional guillotine-type cutting apparatus, a detailed description thereof will be omitted.

The electrode sheet S is transported between the upper blade 110 mounted on the upper blade holder 112 and the lower blade 120 mounted on the lower blade holder 122, and the rear surface side of the upper blade 110 and the front surface side of the lower blade 120 overlap to cut the electrode sheet S, thereby manufacturing the unit electrode U.

For example, the upper blade 110 may operate to move up and down toward the lower blade 120 to cut the electrode sheet S, or conversely, the lower blade 120 may operate to move up and down toward the upper blade 110 to cut the electrode sheet S.

Alternatively, the upper blade 110 and the lower blade 120 may operate to move up and down in an interlocked manner to cut the electrode sheet S.

The adjustment assembly 130 includes an upper blade holder support 132 for mounting the upper blade holder 112, and a clearance adjustment unit 150 and a squareness adjustment unit 160 for adjusting the clearance and squareness between the upper blade 110 and the lower blade 120 by elastically pressing and tilting the upper blade holder 112.

The upper blade holder support 132 includes first and second mount frames 134 and 136, and adjustment shafts 140 supporting the upper blade holder 112 between the first and second mount frames 134 and 136.

The first and second mount frames 134 and 136 are formed to extend in the width direction of the electrode sheet S, and the second mount frame 136 is fixedly installed to the first mount frame 134 via fastening bolts such that a front surface thereof faces a rear surface of the first mount frame 134.

At this time, an adjustment groove 138 into which the upper side of the upper blade holder 112 is fitted so as to be movable back and forth and tiltable is formed in the first mount frame 134, and the adjustment groove 138 is formed to be opened toward the rear surface side of the first mount frame 134 while extending from a lower portion to an upper side of the first mount frame 134.

Meanwhile, the adjustment shafts 140 horizontally pass through through-holes 114 formed on the upper side of the upper blade holder 112 so as to be spaced apart at predetermined intervals, and ball bushings 116 are fixedly installed in the through-holes 114 so that the upper blade holder 112 can smoothly move back and forth along the adjustment shafts 140.

The adjustment shafts 140 are inserted into the adjustment groove 138 together with the upper side of the upper blade holder 112 and are tiltably supported by the first and second mount frames 134 and 136.

To this end, first and second tilting grooves 142 and 144 into which front ends and rear ends of the adjustment shafts 140 are tiltably fitted are formed in the first and second mount frames 134 and 136.

At this time, the front ends of the adjustment shafts 140 are fitted into the first tilting groove 142 via self-aligning ball bearings 146, and the second tilting groove 144 is formed in the shape of a long hole extending in the vertical direction so that the rear ends of the adjustment shafts 140 can be tilted in the vertical direction.

That is, the front ends of the adjustment shafts 140 fitted into the first tilting groove 142 via the self-aligning ball bearings 146 serve as a center of rotation during tilting for adjusting the squareness between the upper blade 110 and the lower blade 120.

The clearance adjustment unit 150 is installed on the first mount frame 134 corresponding to the adjustment shafts 140, and the squareness adjustment unit 160 is installed on the second mount frame 136 corresponding to the adjustment shafts 140.

The clearance adjustment unit 150 may include a plurality of clearance adjustment mechanisms.

Each mechanism includes a clearance adjustment bolt 154 and a clearance adjustment compression coil spring 156.

The clearance adjustment compression coil spring 156 is fitted into the first mount frame 134 so that a rear end thereof can press the front side of the upper blade holder 112 inserted into the adjustment groove 138.

To this end, a clearance adjustment hole 152 into which the clearance adjustment compression coil spring 156 is fitted is formed in the first mount frame 134.

The clearance adjustment bolt 154 is fastened to the clearance adjustment hole 152 so that the clearance adjustment compression coil spring 156 can elastically press the front surface of the upper blade holder 112.

That is, when the clearance adjustment bolt 154 is inserted into or withdrawn from the clearance adjustment hole 152, the pressure of the clearance adjustment compression coil spring 156 changes.

According to the pressure change of the clearance adjustment compression coil spring 156, the upper blade holder 112 moves back and forth along the adjustment shafts 140, and according to the back and forth movement of the upper blade holder 112, the clearance between the upper blade 110 and the lower blade 120 is quantitatively adjusted.

Meanwhile, the squareness adjustment unit 160 may include a plurality of squareness adjustment mechanisms.

Each mechanism includes a squareness adjustment bolt 164 and a squareness adjustment compression coil spring 166.

The squareness adjustment compression coil spring 166 is fitted into the second mount frame 136 so that an upper end thereof can elastically support a lower side connected to the rear end of the corresponding adjustment shaft 140 fitted into the second tilting groove 144.

The squareness adjustment bolt 164 is fastened to the second mount frame 136 so as to press an upper side connected to the rear end of the corresponding adjustment shaft 140 fitted into the second tilting groove 144.

To this end, a first squareness adjustment hole 162a into which the squareness adjustment compression coil spring 166 is fitted is formed to be recessed at a lower side of the second tilting groove 144 of the second mount frame 136, and a second squareness adjustment hole 162b into which the squareness adjustment bolt 164 is fastened is formed to pass through the upper portion of the second mount frame 136 at an upper side of the second tilting groove 144.

That is, when the squareness adjustment bolt 164 is inserted into or withdrawn from the second squareness adjustment hole 162b, the rear ends of the adjustment shafts 140 are tilted up and down with the self-aligning ball bearings 146 as the center of rotation.

As the adjustment shafts 140 are tilted up and down, the upper blade holder 112 and the upper blade 110 are tilted in the vertical direction, so that the squareness between the upper blade 110 and the lower blade 120 is quantitatively adjusted.

Although three adjustment shafts 140, and the clearance adjustment unit 150 and the squareness adjustment unit 160 having three adjustment mechanisms corresponding to the three adjustment shafts 140 are shown in FIGS. 1 and 2, the number of the adjustment shafts 140 and the mechanisms of the adjustment units 150 and 160 is not limited to three, and they may be added or subtracted according to the lengths of the upper blade 110 and the lower blade 120.

Since the cartridge-type secondary battery electrode cutting module 100 according to the present invention formed as described above facilitates the adjustment of the clearance and squareness between the upper blade 110 and the lower blade 120, it allows anyone, even if not a skilled worker, to easily adjust the clearance and squareness between the upper blade 110 and the lower blade 120.

In addition, since the cartridge-type secondary battery electrode cutting module 100 according to the present invention can quantitatively guarantee the clearance and squareness between the upper blade 110 and the lower blade 120, it ensures that consistent cutting quality is maintained.

What is claimed is:

1. A cartridge-type secondary battery electrode cutting module comprising:
an upper blade configured to be mounted on an upper blade holder;
a lower blade configured to be mounted on a lower blade holder; and
an adjustment assembly having an upper blade holder support for mounting the upper blade holder, and
a clearance adjustment unit and a squareness adjustment unit for adjusting a clearance and squareness between the upper blade and the lower blade by elastically pressing and tilting the upper blade holder.

2. The cartridge-type secondary battery electrode cutting module of claim 1,
wherein the upper blade holder support comprises:
a first mount frame formed to extend in a width direction of an electrode sheet;
a second mount frame formed to extend in the width direction of the electrode sheet and fixedly installed to the first mount frame such that a front surface thereof faces a rear surface of the first mount frame; and
adjustment shafts that horizontally pass through through-holes formed on an upper side of the upper blade holder so as to be spaced apart from each other, and support the upper blade holder between the first and second mount frames such that the upper blade holder can move back and forth and tilt.

3. The cartridge-type secondary battery electrode cutting module of claim 2, wherein an adjustment groove into which the upper side of the upper blade holder is fitted so as to be movable back and forth and tiltable is formed in the first mount frame, and wherein the adjustment groove is formed to be opened toward the rear surface side of the first mount frame while extending from a lower portion to an upper side of the first mount frame.

4. The cartridge-type secondary battery electrode cutting module of claim 2, wherein a first tilting groove into which front ends of the adjustment shafts are tiltably fitted via self-aligning ball bearings is formed in the first mount frame, and wherein a second tilting groove extending in a vertical direction, into which rear ends of the adjustment shafts are tiltably fitted in the vertical direction, is formed in the second mount frame.

5. The cartridge-type secondary battery electrode cutting module of claim 2, wherein ball bushings are fixedly installed in the through-holes so that the upper blade holder can move back and forth along the adjustment shafts.

6. The cartridge-type secondary battery electrode cutting module of claim 2, wherein the clearance adjustment unit comprises a plurality of clearance adjustment mechanisms, each mechanism comprising:
a clearance adjustment compression coil spring fitted into a clearance adjustment hole formed in the first mount frame such that a rear end thereof can press a front side of the upper blade holder; and
a clearance adjustment bolt fastened to be inserted into or withdrawn from the clearance adjustment hole to allow the clearance adjustment compression coil spring to elastically press the front surface of the upper blade holder.

7. The cartridge-type secondary battery electrode cutting module of claim 4, wherein the squareness adjustment unit comprises a plurality of squareness adjustment mechanisms, each mechanism comprising:
a squareness adjustment compression coil spring fitted into a first squareness adjustment hole formed at a lower side of the second tilting groove, an upper end of which elastically supports a lower side connected to the rear end of a corresponding one of the adjustment shafts; and
a squareness adjustment bolt fastened to be inserted into or withdrawn from a second squareness adjustment hole formed through an upper portion of the second mount frame at an upper side of the second tilting groove, to press an upper side connected to the rear end of the corresponding one of the adjustment shafts so as to tilt the upper blade holder and the upper blade in the vertical direction.
